(19) United States
(12) Patent Application Publication
(10) Pub. No.: US 2025/0148768 A1
(43) Pub. Date: May 8, 2025

(54) OPEN VOCABULARY ACTION DETECTION

(71) Applicant: NEC Laboratories America, Inc., Princeton, NJ (US)

(72) Inventors: Kai Li, Plainsboro, NJ (US); Deep Patel, Franklin Park, NJ (US); Renqiang Min, Princeton, NJ (US); Wentao Bao, Princeton, NJ (US)

(21) Appl. No.: 18/937,628

(22) Filed: Nov. 5, 2024

Related U.S. Application Data
(60) Provisional application No. 63/596,676, filed on Nov. 7, 2023.
(60) Provisional application No. 63/548,545, filed on Nov. 14, 2023.

(51) Int. Cl. G06V 10/80; G06V 10/82; G06V 20/40; G06V 20/58; G06V 40/20

(52) U.S. Cl. CPC G06V 10/806; G06V 20/41; G06V 20/49; G06V 40/20; G06V 10/82; G06V 20/58

(57) ABSTRACT

Methods and systems for action detection include encoding a text feature of an input textual description of an action using a visual language model (VLM). A video feature of an input video is encoded using the VLM. The action in the video is recognized, based on the text feature and the video feature, to localize the action within the video. A person performing the action is located within the video using the VLM.

### RELATED APPLICATION INFORMATION

This application claims priority to U.S. Patent Application No. 63/596,676, filed on Nov. 7, 2023, and to U.S. Patent Application No. 63/548,545, filed on Nov. 14, 2023, each incorporated herein by reference in its entirety.

### BACKGROUND

### Technical Field

The present invention relates to action detection and, more particularly, using language models to expand the vocabulary of an action detection system.

### Description of the Related Art

Video action detection aims to recognize human activities within video streams. Action detection is used to provide a high-level understanding of video content, which can be used to make recommendations in social media applications, for video editing, and to assist in autonomous driving. However, action detection that is limited to a closed set of predefined categories may be limited in its applicability to real world scenarios, where any kind of human action could be performed.

### SUMMARY

A method for action detection includes encoding a text feature of an input textual description of an action using a visual language model (VLM). A video feature of an input video is encoded using the VLM. The action in the video is recognized, based on the text feature and the video feature, to localize the action within the video. A person performing the action is located within the video using the VLM.

A system for action detection includes a hardware processor and a memory that stores a computer program. When executed by the hardware processor, the computer program causes the hardware processor to encode a text feature of an input textual description of an action using a VLM, to encode a video feature of an input video using the VLM, to recognize the action in the video, based on the text feature and the video feature, to localize the action within the video, and to locate a person performing the action within the video using the VLM.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing an action detection task within a video, in accordance with an embodiment of the present invention;

FIG. 2 is a block/flow diagram of action detection and person localization using an open vocabulary, in accordance with an embodiment of the present invention;

FIG. 3 is a block/flow diagram of location sampling in an action detection system, in accordance with an embodiment of the present invention;

FIG. 4 is a block/flow diagram of semantic fusion in an action detection system, in accordance with an embodiment of the present invention;

FIG. 5 is a block/flow diagram of a mixer model in an action detection system, in accordance with an embodiment of the present invention;

FIG. 6 is a block/flow diagram of a mixer model, in accordance with an embodiment of the present invention;

FIG. 7 is a block/flow diagram of a spatial mixer, in accordance with an embodiment of the present invention;

FIG. 8 is a block/flow diagram of a temporal mixer, in accordance with an embodiment of the present invention;

FIG. 9 is a block/flow diagram of a method of recognizing and responding to an action in a video, in accordance with an embodiment of the present invention;

FIG. 10 is a diagram of a computing device that can detect and respond to actions in a video, in accordance with an embodiment of the present invention;

FIG. 11 is a diagram of an exemplary neural network architecture that can be used to implement a machine learning model, in accordance with an embodiment of the present invention; and

FIG. 12 is a diagram of an exemplary deep neural network architecture that can be used to implement a machine learning model, in accordance with an embodiment of the present invention.

### DETAILED DESCRIPTION OF PREFERRED EMBODIMENTS

Open vocabulary action detection aims to detect video actions in an open world, without being limited to predefined categories. A visual language model (VLM) is used to expand the vocabulary of the action detection system. Semantics and location priors of the VLM are used to prevent overfitting of the learnable action recognition to actions that have been defined by task-specific training data, which could otherwise result in poor generalization to previously unseen actions. The localization capability of the VLM is furthermore enhanced to provide more accurate identification of the location of the person performing the action within a video frame.

To handle overfitting, where the VLM-based action recognition is trained on videos of particular actions, the video features of pretrained VLMs may be fused with a learnable action recognition head. Pretrained VLM features have the capability for strong generalization to detect previously unseen actions, while the learnable action recognition head adapts the video features to detect the task-relevant seen actions. A dynamic feature fusion naturally takes the merits of both, leading to good performance in detecting both previously seen actions and previously unseen actions.

To improve localization, the top K locations may be sampled over a visual attention map, generated from patch-text similarity based on the VLM. The patch-text similarity from the visual transformer-based VLM indicates the importance of each pixel with respect to textual action. With the sampled locations as the input of the model, the action-relevant persons in a frame can be more easily detected. In addition, the sampled locations are also generalizable prior knowledge across the seen and unseen actions, so that they can also benefit in the detection of previously unseen actions.

Open vocabulary action detection is challenging as it calls for an understanding of human motion dynamics across frames. Thus open vocabulary action detection can be targeted using a large-scale pretrained VLM, with semantics fusion being used to combine pretrained video features from the VLM and the learnable video features from task-specific datasets. Localization takes advantage of the VLM's localization capabilities to localize action-relevant persons in the video.

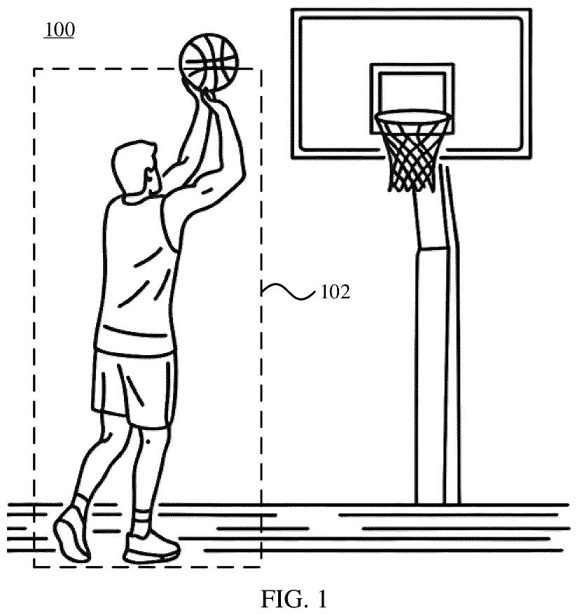

Referring now to FIG. 1, an exemplary frame 100 from a video stream is shown. In the video, a man is shooting a basketball toward a hoop. Action detection identifies the action that is being performed and person localization identifies where the person is who is performing that action, for example by generating coordinates for a bounding box 102 around the person. The identified action may be provided as a textual output, with a natural language description of the action within the frame 100.

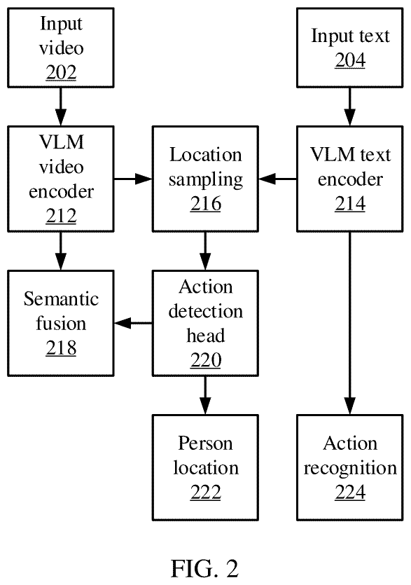

Referring now to FIG. 2, a diagram of an action detection model is shown. During training, datasets may be employed which include videos and corresponding descriptive text that labels the actions taking place. This input is processed as input video 202 and input text 204, with the input text 204 specifically describing corresponding input video 202. A VLM video encoder 212 and a VLM text encoder 214 process the input video 202 and the input text 204, respectively, to generate embeddings of each. The parameters of the VLM video encoder 212 and the VLM text encoder 214 are kept fixed during training—these components are pre-trained and are not altered during the action detection training.

Location sampling 216 takes the VLM video features output by the VLM video encoder 212 and the VLM text features output by the VLM text encoder 214 as input and generates initial locations for training the action detection head 220. The action detection head 220 is trained to localize 222 the person performing an action within a frame, and so may output a corresponding bounding box. To exploit the video VLM localizability for region-wise localization, a set of queries is learned to decode the person boxes, starting from the prior locations revealed by VLM visual attention. Semantic fusion 218 uses the VLM video features in conjunction with the bounding box to align with the VLM text feature. This alignment is performed using an alignment loss that forces the text features corresponding to an action in the video to align with each other, as described in greater detail below.

During inference, the input text 204 is a textual description of the actions that are being detected. This kind of action description goes into the text encoder 214, which outputs a set of features for each description, which are then aligned or matched with the detected person features in the video. The alignment includes matrix multiplication between the text features and the person features and using a softmax function to convert the matching into probabilities. If the action text features and the person features match to within a certain threshold (e.g., using a similarity metric between the respective vectors such as cosine similarity), then the model determines that the person is performing the action in the video.

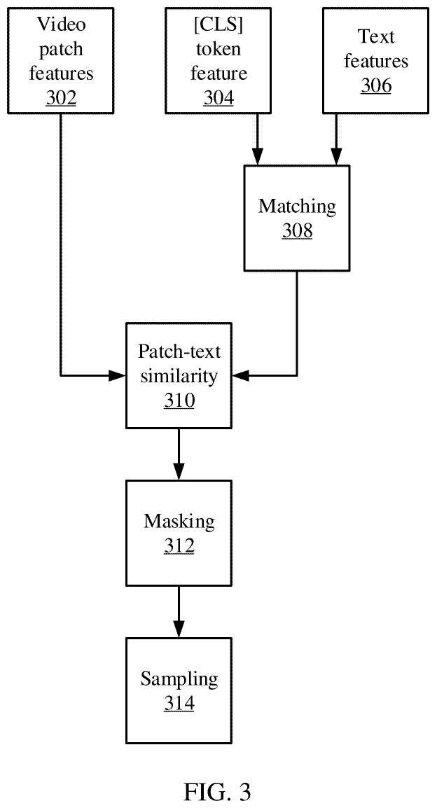

Referring now to FIG. 3, additional detail on the location sampling 216 is shown. Given a video input, the VLM video encoder 212 generates video patch features 302 and [CLS] token feature 304 (where “CLS” stands for “classify”). The [CLS] token feature 304 and the text features 306 are processed in matching 308, with the matched features being used along with video patch features 302 to compute a patch-text similarity map 310.

The video features from VLM are extracted using the video encoder 212. These are output as video patch features 302 over the entire video clip, including patches from each frame and a corresponding [CLS] token 304. For example, if a video has eight frames and a resolution of 224×224, it may be split into multiple patches of a fixed size (e.g., 16×16) and may be converted into a sequence of tokens. A learned parameter, called the [CLS] token 304, is appended to the sequence. The text features 306 for all the action class descriptions are extracted from the VLM text encoder 214. The patch text similarity 310 is obtained by an inner dot product between the text features 306 and video patch features 302.

Block 312 masks the patch-text similarity map by applying a threshold with a median intensity value. Points in the map having an intensity higher than the threshold are kept and other points are masked to remove them from the map. Sampling 314 is performed to select the locations of the top-K highest density values as the initial locations for the input of the downstream action detection head 220. The value for K may be selected based on heuristics. If a large number of people are expected in the video frames, then K may be selected to be a large number (e.g., 100).

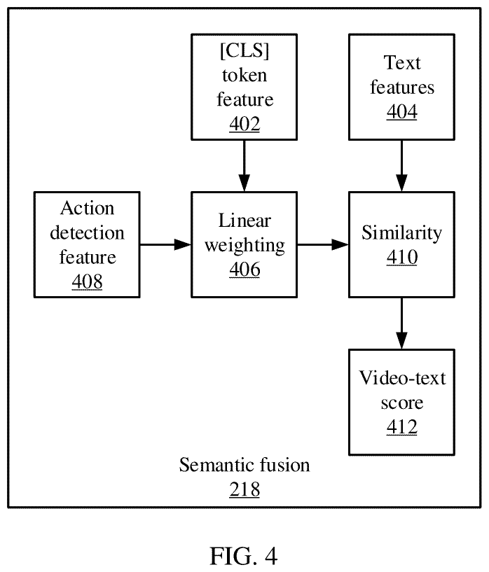

Referring now to FIG. 4, additional detail on the semantic fusion 218 is shown. Given the [CLS] token feature 402 for an input video and the action detection feature 408 output by action detection head 220, linear weighting is used to fuse the features with a learnable fusion weight, with the weights being learned during training. Similarities 410 are determined between the fused features and text features 404 for words from a vocabulary list, for example performed as a cosine similarity between the respective feature vectors. The vocabulary list is a list of class names from the labels in the training dataset. The maximum similarity over the vocabulary list is the video-text alignment score 412, which indicates the action category of the input video.

Thus video-level semantics are transferred to each region, with a set of region-wise queries being learned to decode temporal dynamics from the videos using pre-trained video-level features as adaptive semantic conditions. The updated queries and video-level features are fused and aligned with textual semantics for recognition.

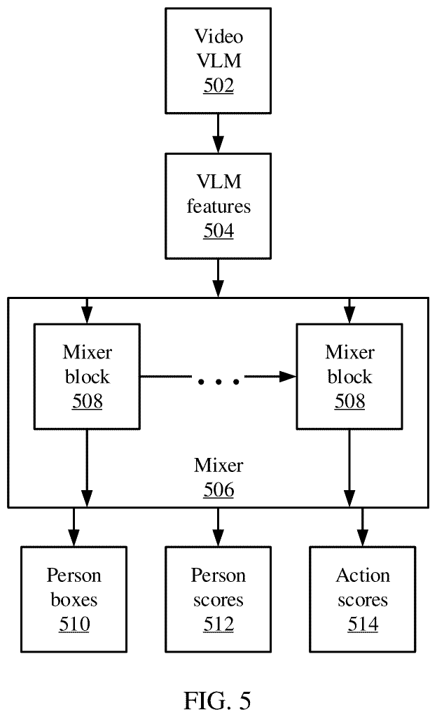

Referring now to FIG. 5, an arrangement of mixer blocks is shown to handle action detection as a set-to-set prediction problem, learning a sparse set of query features from videos to match with ground truth boxes and action classes. Action classes are predicted from an open vocabulary that includes base and novel actions.

As above, the input video 202 and associated action text 204 are input to a video VLM 502, which includes the VLM video encoder 212 and the VLM text encoder 214. The output VLM features 504 include the outputs of the respective encoders on a frame-by-frame basis and are provided as inputs to a mixer 506 with respective mixer blocks 508 handling each frame.

The mixer 506 outputs a set of person boxes 510, person scores 512, and action scores 514 for each frame, output by the respective mixer blocks 508. Each mixer block 508 outputs its frame's person boxers to the next mixer block 508 to use as a basis for person localization in the next frame.

Thus, given a video X and a list of text prompted action classes y as input, the visual encoder Ψ_{VE} and the text encoder Ψ_{TE} of the video VLM 502 are used to obtain features of the video V, f_{V}, S=Ψ_{VE} (X) and action text fₜ=Ψ_{TE} (y). Here V, fᵥ, and S are the four-dimensional patch-level video feature, the video-level feature, and the video attention, respectively, and fₜ is the text feature of a class y. The M mixer blocks 508 learn a set of N spatial queries Qₛ and N temporal queries Qₜ from (V, S, fᵥ, fₜ) for person detection and action classification, respectively. The mixer blocks 506 take as input all of the VLM features 504 and the queries Qₛ and Qₜ.

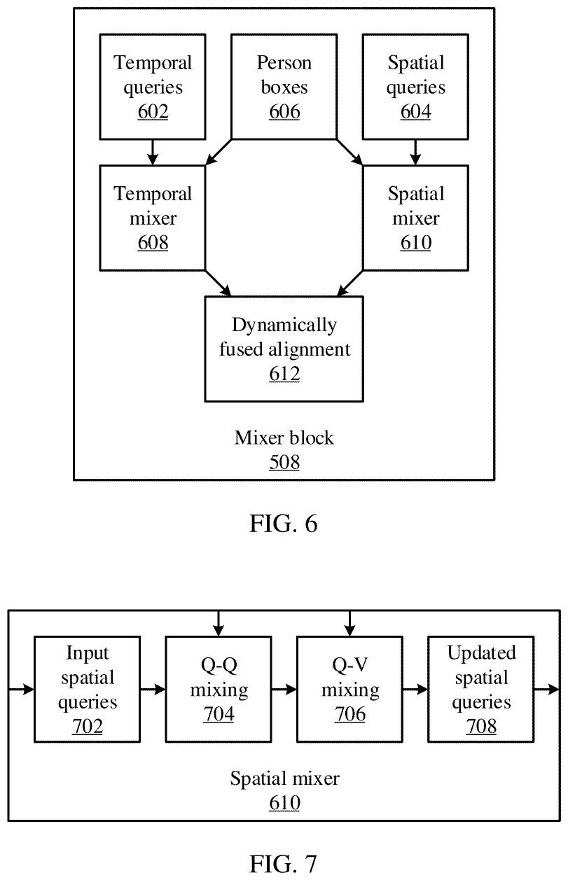

Referring now to FIG. 6, additional detail on the mixer blocks 508 is shown. For the m^{th} mixer block 508, a temporal mixer block 608 implements Ψ_{α} and a spatial mixer block 610 implements Ψ_{θ}. The spatial mixer block 610 includes prior location sampling, query-query mixing by self-attention, and query-video mixing, while the temporal mixer block 608 sequentially applies query-query mixing, query conditioning, and query-video mixing. A dynamically fused alignment block 612 recursively updates the temporal queries 602 and the spatial queries 604 and person boxes 606 from the (m−1)^{th} mixer block to predict person scores and action scores for the m^{th} video frame.

Referring now to FIG. 7, additional detail on the spatial mixer 610 is shown. The input spatial queries Qₛ 702, either as the initial queries or queries from a previous mixer block 508, are processed by query-query mixing 704 and query-video mixing 706 to generate updated spatial queries \hat{Q}ₛ 708, which are output to the next mixer block 508 and which are used to generate person scores and location boxes for the present video frame. The query-query mixing 704 and the query-video mixing 706 both receive location boxes from the previous mixer block 508 as inputs, and the query-video mixing 706 further receives features V.

A lack of prior knowledge of object locations can contribute to low localization convergence. The visual attention from the VLM is used to supply this information. Visual attention maps may be represented by a class activation map (CAM) to visually explain a recognition model. An efficient and structure-agnostic CAM may be used on patch-text correlation as a VLM attention to encode location priors.

Specifically, with a D-dimensional 4D video feature V∈ [symbol] ^{T×hw×D}, where T is a number of frames and hw is the number of visual tokens in each frame, the holistic video feature fᵥ∈ [symbol] ^{D}, and the text features of C classes as [symbol] ₜ=[fₜ⁽¹⁾, . . . , fₜ^{(C)}]^{T}, the features are L₂ normalized. The pre-matched text feature fₜ is determined by maximum similarity:

$${f}_{t} = {arg max}_{{f}_{t} ∈ {ℱ}_{t}} {f}_{v}^{T} ⊗ {f}_{t}$$

as the class label is not available during testing. Thus the inner product between fₜ and V determines the patch-text correlation: S=V⊕fₜ. The query-video attention in self-attention layers shows an opposite heatmap, where the foreground regions are associated with low attention values. In practice, the CAM is determined by the reversed patch-text similarity: Ŝ=1−S. By reshaping and spatial interpolation over Ŝ, the attention map is obtained for prior location sampling. The Ŝ is treated as the prior distribution of person locations indicated by the VLM, thus the top-N positions are sampled as the initial box centers:

$$\{ {( u . v )}_{i} \vert i = 1 , … , N \} ∼ \hat{S} ( u , v , k )$$

where (u, v) are two-dimensional coordinates on key frame k and where N is the number of queries.

With the sampled prior locations, the spatial mixer 610 takes as input the video patch features V and the box predictions \hat{b}ₘ₋₁ of the previous (m−1)^{th} stage to update the spatial queries by:

$${\hat{Q}}_{s} = {Ψ}_{{θ}_{m}} ( V , {Q}_{s} , {\hat{b}}_{m - 1} )$$

The updated spatial queries \hat{Q}ₛ are used to predict the person scores ôₘ and person box offsets Δ\hat{b}ₘ by a multi-layer perceptron. Then the predicted boxes at stage m are updated by \hat{b}ₘ=\hat{b}ₘ₋₁+Δ\hat{b}ₘ, where initial box queries \hat{b}₀ include the sampled prior locations and the video spatial range. The spatial mixer 610 thus learns the box offset Δb from the prior locations inherited from the pre-trained VLM. The VLM's attention-based prior locations are adaptive to test-time video content and vocabulary, which improves the seen action localization as well as generalization to unseen vocabulary.

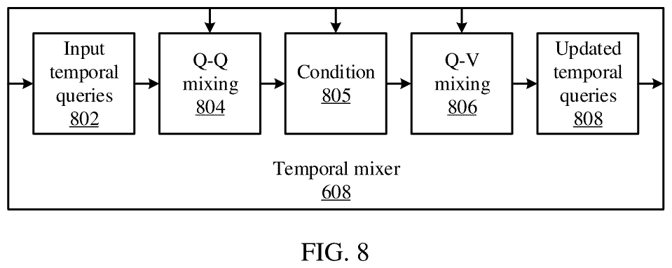

Referring now to FIG. 8, additional detail on the temporal mixer 608 is shown. The input temporal queries Qₛ 802, either as the initial queries or queries from a previous mixer block 508, are processed by query-query mixing 804. A condition 805 is applied based on the video features fᵥ. Query-video mixing 806 is then used to generate updated temporal queries \hat{Q}ₜ 808, which are output to the next mixer block 508. The query-query mixing 804 and the query-video mixing 806 both receive location boxes from the previous mixer block 508 as inputs.

The dynamically fused alignment block 612 takes the feature vector fᵥ and the updated temporal queries \hat{Q}ₜ as inputs from the temporal mixer 608, along with the text features fₜ, and combines them to form action scores.

For query-based models, temporal queries are expected to be discriminative for both base and new actions. The query-video mixing 806 thus provides strong content decoding. Adaptive semantics from the pre-trained VLM are used to prevent overfitting to seen class data. The temporal queries Qₜ are thus updated at the current stage m by interacting with video features V and fᵥ by the function \hat{Q}ₜ=Ψ_{α}_{ₘ}(V, Qₜ, fᵥ, \hat{b}ₘ). The query is updated as:

$${\hat{Q}}_{t} = {Ψ}_{q v} ( {Ψ}_{q q} ( {Q}_{t} , b ) ⊕ {f}_{v} , V , b )$$

where Ψ_{qq} and Ψ_{qv} are functions that implement the query-query mixing 804 and the query-video mixing 806, respectively. Here fᵥ applies the adaptive semantic condition 805 by the pre-trained VLM video feature, which is broadcast-added to the output of the query-query mixing 804. The adaptiveness of the semantic condition 805 stems from the test-time video feature fᵥ. This precondition is superior to a postcondition because of the better query features used to learn the query-video mixing 806.

To recognize both seen and unseen actions, the model learns discriminative region-wise visual features to align with seen actions, while keeping the generalizable knowledge of the pre-trained VLM to align with the unseen actions. The dynamically fused alignment 612 is used for open vocabulary action recognition, being formulated to learn the action classification at each stage: ŷₘ=Ψ_{λ}_{ₘ}(\hat{Q}ₜ, fᵥ, fₜ), where ŷₘ are the predicted actions for all queries \hat{Q}ₜ and the λₘ are the learnable parameters. This includes dynamic feature fusion and query-text alignment.

Dynamic feature fusion aims to fuse the video-level feature fᵥ into each of the queries \hat{Q}ₜ dynamically. The fᵥ is repeated N times to produce Fᵥ∈ [symbol] ^{N×D}. This is fused with \hat{Q}ₜ as \tilde{F}ᵥ=λ⊙Fᵥ+(1−λ)⊙\hat{Q}, where λ∈ [symbol] ^{(N×1)} are learnable in training. The query-specific learnable parameters allow dynamic contributions of the video-level knowledge from fᵥ to different learnable queries in the set-matching training.

To make the classification decision by \tilde{F}ᵥ and open vocabulary of actions, for the action category, a large language model (LLM) may be used to generate multiple visually descriptive action prompts for each category. With the VLM text encoder 214, the aggregated text features of the C classes are represented as Fₜ∈ [symbol] . The softmax of visual-text cosine similarity is used to represent the multi-class classification probability P(ŷ|\hat{Q})=softmax(\hat{F}ᵥ⊗Fₜ^{T}/τ), where τ is the VLM temperature. The open-vocabulary action recognition for all queries is achieved by finding the maximum visual-text cosine similarity:

$$\hat{y} = {arg max}_{y ∈ 𝒞} ( {\hat{F}}_{v} ⊗ {F}_{t}^{T} ) .$$

The spatial queries Qₛ are not included in this process as an input to the dynamic fused alignment 612, so that the temporal mixer 608 and the spatial mixer 610 are decoupled in training, producing a person localization which is class-agnostic.

During training, a loss function [symbol] ₛₑₜ= [symbol] _{bce}+ [symbol] _{L}_{₁}+ [symbol] _{GIoU} may combine [symbol] _{bce} as a binary cross-entropy loss for person score prediction, [symbol] _{L}_{₁} as a coordinate distance between predicted and ground truth boxes, and [symbol] _{GIoU} as the generalized intersection over union loss between predicted and ground truth boxes. Hungarian matching may be used to find the optimal bipartite matching between the predicted and ground truth boxes for each training video. For action recognition, a multi-class cross-entropy loss [symbol] _{act} is used so that the total loss function is [symbol] ₜₒₜₐₗ=w₁ [symbol] ₛₑₜ+w₂ [symbol] _{act}, where w₁ and w₂ are hyperparameters to set the relative weights of the different loss contributions. During inference, the thresholded person scores determine the kept person boxes, while the action scores assign the action categories to boxes from input class categories.

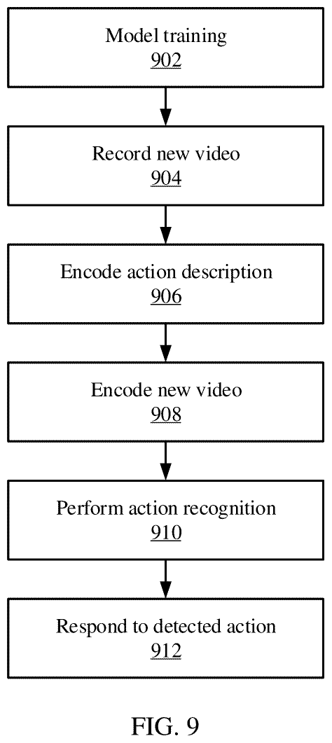

Referring now to FIG. 9, a method of performing open vocabulary action detection is shown. Block 902 trains the model as described above, using any appropriate training dataset that may include annotated video streams. The training 902 may be performed well in advance of implementation of the model, and may be performed in a different location and by a different party relative to the subsequent steps. However, it is also contemplated that the steps of this process may be performed by a single party or separately by any number of different parties.

Block 904 records a new video stream. This step may be performed before training model training 902, concurrently with that training, or subsequent to that training. The new video may include a set of frames that includes one or more actions of interest, but may be unlabeled. In at least one embodiment, the new video may include video of a sporting event where one or more individuals performs actions relating to the sport. In another embodiment the new video may be a video captured by a self-driving vehicle, showing pedestrians performing activities in the environment around the vehicle.

Block 906 encodes an action description relating to an action that is being sought in the video. This may include multiple such action descriptions, relating to different actions of interest. Block 908 encodes the new video.

Block 910 performs open vocabulary action detection on the new video using the trained model. The model may output include labels for the action being performed as well as bounding boxes that identify the location of a person performing the action. The output may include labels for multiple such actions within a single new video, performed by one or more actors. The labels are not limited to action classes that are present in the training dataset, but may include previously unseen action classes.

Based on the labels generated by the model for the new video, block 912 performs a responsive action. Following the above example of a sporting event, the responsive action may include automatically generating additional information relating to the detected action such as an identification of the actor, statistics relating to the actor or the detected action, and updates to the state of the sporting event based on the outcome of the action. Other uses for temporal action localization include security monitoring, for example identifying hazardous events in a video feed, and video labeling to segment videos based on semantic meaning to aid in summarizing important information from the video.

In some cases, the action of block 912 may include a driving action. For example, if block 910 identifies a person who is walking toward the vehicle or otherwise about to cause a hazardous event, block 912 may perform a steering action, acceleration action, or braking action to avoid or mitigate the hazardous event.

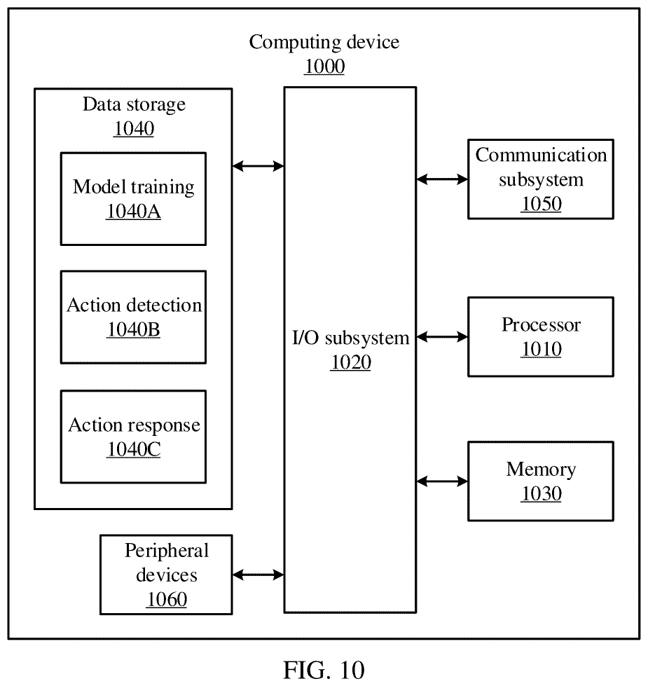

Referring now to FIG. 10, an exemplary computing device 1000 is shown, in accordance with an embodiment of the present invention. The computing device 1000 is configured to perform open vocabulary action detection.

The computing device 1000 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 1000 may be embodied as one or more compute sleds, memory sleds, or other racks, sleds, computing chassis, or other components of a physically disaggregated computing device.

As shown in FIG. 10, the computing device 1000 illustratively includes the processor 1010, an input/output subsystem 1020, a memory 1030, a data storage device 1040, and a communication subsystem 1050, and/or other components and devices commonly found in a server or similar computing device. The computing device 1000 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 1030, or portions thereof, may be incorporated in the processor 1010 in some embodiments.

The processor 1010 may be embodied as any type of processor capable of performing the functions described herein. The processor 1010 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 1030 may be embodied as any type of volatile or non-volatile memory or data storage capable of performing the functions described herein. In operation, the memory 1030 may store various data and software used during operation of the computing device 1000, such as operating systems, applications, programs, libraries, and drivers. The memory 1030 is communicatively coupled to the processor 1010 via the I/O subsystem 1020, which may be embodied as circuitry and/or components to facilitate input/output operations with the processor 1010, the memory 1030, and other components of the computing device 1000. For example, the I/O subsystem 1020 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 1020 may form a portion of a system-on-a-chip (SOC) and be incorporated, along with the processor 1010, the memory 1030, and other components of the computing device 1000, on a single integrated circuit chip.

The data storage device 1040 may be embodied as any type of device or devices configured for short-term or long-term storage of data such as, for example, memory devices and circuits, memory cards, hard disk drives, solid state drives, or other data storage devices. The data storage device 1040 can store program code 1040A for performing training of the model, 1040B for open vocabulary action detection, and/or 1040C for responding to detected actions. Any or all of these program code blocks may be included in a given computing system. The communication subsystem 1050 of the computing device 1000 may be embodied as any network interface controller or other communication circuit, device, or collection thereof, capable of enabling communications between the computing device 1000 and other remote devices over a network. The communication subsystem 1050 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 1000 may also include one or more peripheral devices 1060. The peripheral devices 1060 may include any number of additional input/output devices, interface devices, and/or other peripheral devices. For example, in some embodiments, the peripheral devices 1060 may include a display, touch screen, graphics circuitry, keyboard, mouse, speaker system, microphone, network interface, and/or other input/output devices, interface devices, and/or peripheral devices.

Of course, the computing device 1000 may also include other elements (not shown), as readily contemplated by one of skill in the art, as well as omit certain elements. For example, various other sensors, input devices, and/or output devices can be included in computing device 1000, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1000 are readily contemplated by one of ordinary skill in the art given the teachings of the present invention provided herein.

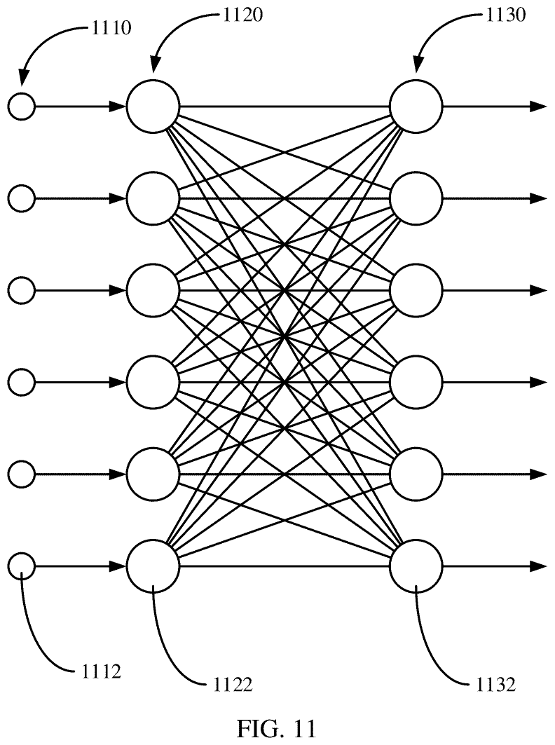

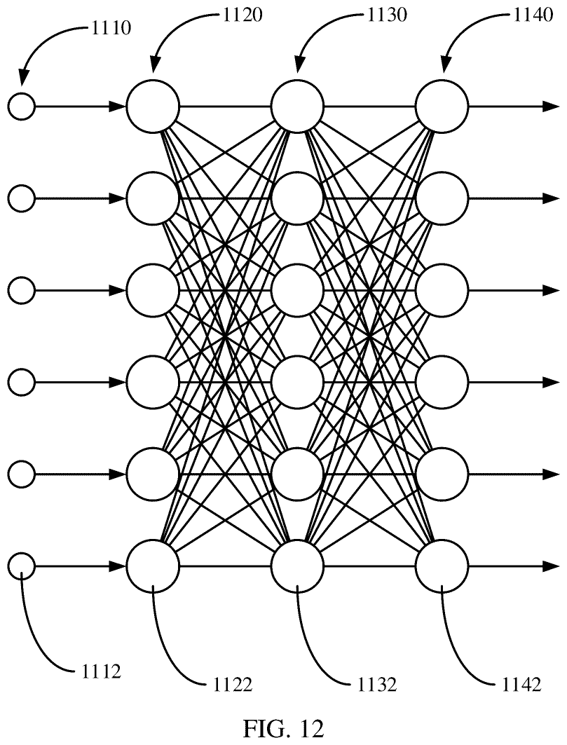

Referring now to FIGS. 11 and 12, exemplary neural network architectures are shown, which may be used to implement parts of the present models. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 1120 of source nodes 1122, and a single computation layer 1130 having one or more computation nodes 1132 that also act as output nodes, where there is a single computation node 1132 for each possible category into which the input example could be classified. An input layer 1120 can have a number of source nodes 1122 equal to the number of data values 1112 in the input data 1110. The data values 1112 in the input data 1110 can be represented as a column vector. Each computation node 1132 in the computation layer 1130 generates a linear combination of weighted values from the input data 1110 fed into input nodes 1120, and applies a non linear activation function that is differentiable to the sum. The exemplary simple neural network can perform classification on linearly separable examples (e.g., patterns).

A deep neural network, such as a multilayer perceptron, can have an input layer 1120 of source nodes 1122, one or more computation layer(s) 1130 having one or more computation nodes 1132, and an output layer 1140, where there is a single output node 1142 for each possible category into which the input example could be classified. An input layer 1120 can have a number of source nodes 1122 equal to the number of data values 1112 in the input data 1110. The computation nodes 1132 in the computation layer(s) 1130 can also be referred to as hidden layers, because they are between the source nodes 1122 and output node(s) 1142 and are not directly observed. Each node 1132, 1142 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 1132 in the one or more computation (hidden) layer(s) 1130 perform a nonlinear transformation on the input data 1112 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “AB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for action detection, comprising:
encoding a text feature of an input textual description of an action using a visual language model (VLM);
encoding a video feature of an input video using the VLM;
recognizing the action in the video, based on the text feature and the video feature, to localize the action within the video; and
locating a person performing the action within the video using the VLM.

2. The method of claim 1, wherein recognizing the action includes applying a model that applies a mixer to each frame of the input video.

3. The method of claim 2, wherein the mixer recursively updates temporal queries, spatial queries, and person boxes from a previous video frame to predict person scores and action scores for a current video frame.

4. The method of claim 3, wherein the mixer uses query-query mixing and query-video mixing to update the spatial queries.

5. The method of claim 3, wherein the mixer uses query-query mixing, query-video mixing, and an adaptive semantic condition to update the temporal queries.

6. The method of claim 3, wherein the temporal queries are discriminative of action labels that were used during training as well as previously unseen terms.

7. The method of claim 3, wherein the mixer outputs a box locating the person, a person score to determine that the box is kept, and an action score that assigns an action category to the box.

8. The method of claim 1, wherein recognizing the action includes determining a similarity between the text feature and the video feature.

9. The method of claim 1, further comprising performing a driving action responsive to the action.

10. The method of claim 9, wherein the driving action is selected from the group consisting of a braking action, an acceleration action, and a steering action.

11. A system for action detection, comprising:
a hardware processor; and
a memory that stores a computer program which, when executed by the hardware processor, causes the hardware processor to:
encode a text feature of an input textual description of an action using a visual language model (VLM);
encode a video feature of an input video using the VLM;
recognize the action in the video, based on the text feature and the video feature, to localize the action within the video; and
locate a person performing the action within the video using the VLM.

12. The system of claim 11, wherein recognition of the action includes applying a model that applies a mixer to each frame of the input video.

13. The system of claim 12, wherein the mixer recursively updates temporal queries, spatial queries, and person boxes from a previous video frame to predict person scores and action scores for a current video frame.

14. The system of claim 13, wherein the mixer uses query-query mixing and query-video mixing to update the spatial queries.

15. The system of claim 13, wherein the mixer uses query-query mixing, query-video mixing, and an adaptive semantic condition to update the temporal queries.

16. The system of claim 13, wherein the temporal queries are discriminative of action labels that were used during training as well as previously unseen terms.

17. The system of claim 13, wherein the mixer outputs a box locating the person, a person score to determine that the box is kept, and an action score that assigns an action category to the box.

18. The system of claim 11, wherein recognition of the action includes determining a similarity between the text feature and the video feature.

19. The system of claim 11, wherein the computer program further causes the hardware processor to perform a driving action responsive to the action.

20. The system of claim 19, wherein the driving action is selected from the group consisting of a braking action, an acceleration action, and a steering action.
